(19) United States
(12) Patent Application Publication
(10) Pub. No.: US 2009/0260883 A1
(43) Pub. Date: Oct. 22, 2009

(54) CONTINUOUS MEASUREMENT OF HETEROGENEITY OF GEOMATERIALS

(75) Inventors: ROBERTO SUAREZ-RIVERA, Salt Lake City, UT (US); SIDNEY J. GREEN, Salt Lake City, UT (US); JOEL WESLEY MARTIN, Farmington, UT (US); ROBERT MICHAEL GRIFFIN, Salt Lake City, UT (US)

Correspondence Address: SCHLUMBERGER INFORMATION SOLUTIONS, 5599 SAN FELIPE, SUITE 1700, HOUSTON, TX, 77056-2722, US

(73) Assignee: TerraTek Inc., Salt Lake City, UT (US)

(21) Appl. No.: 12/417,694

(22) Filed: Apr. 3, 2009

Related U.S. Application Data
(60) Provisional application No. 61/045,468, filed on Apr. 16, 2008.

(51) Int. Cl. E21B 25/00; G06F 19/00

(52) U.S. Cl. 175/58; 702/11

(57) ABSTRACT

A method for continuous measurement of heterogeneity of geomaterials. The method includes identifying a core section from a first well within a field, obtaining the core section from the first well, and obtaining a continuous measurement of the core section. The method further includes overlaying the continuous measurement with a portion of a log response for the first well to obtain an overlay, associating an observation with the overlay to obtain an integrated overlay, and analyzing the integrated overlay to determine a heterogeneity of the core section. The method further includes identifying a location in the core section from which to obtain a sample based on the heterogeneity, obtaining the sample from the core section, and analyzing the sample to obtain an analysis result. The method further includes developing a continuous model for the first well using the integrated overlay and the analysis result and presenting the continuous model.

### CROSS-REFERENCE TO RELATED APPLICATIONS

This application claims priority pursuant to 35 U.S.C. § 119(e) to U.S. Provisional Patent Application No. 61/045,468 (Attorney Docket No. 114.0008; 09469/163001) entitled “Method and System For Continuous Measurement of Heterogeneity For Scaling From Micro to Large Scale,” filed Apr. 16, 2008 in the names of Roberto Suarez-Rivera, Sidney Green, J. Wesley Martin, and Robert Griffin, the disclosure of which is incorporated by reference herein in its entirety.

The present application contains subject matter that may be related to subject matter contained in U.S. patent application (Attorney Docket No. 114.0017; 09469/163003), entitled “Apparatus for Continuous Measurement of Heterogeneity of Geomaterials” which is being filed concurrently with the present application, the entire contents of which are incorporated herein by reference. The referenced application also claims priority to U.S. Provisional Patent Application No. 61/045,468 and has the same inventors and assignee as the present application.

### BACKGROUND

Petroleum-related geomaterials are complex materials that are formed by the accumulation of sediments (minerals and fragments from other rocks), are compacted and partially cemented over time, and may be subjected to localized or widespread digenetic alterations that transform their texture and overall composition to their final form. In general, these materials include detrital grains, rock fragments, and a large variety of matrix forming minerals, which may be arranged in various ways, depending on their shapes and size distributions, and in the manner by which they were deposited and altered after deposition. Geomaterials also contain voids (that may be connected or isolated) and pore fluids (water, liquid hydrocarbons or gas). Thus, geomaterials' bulk properties result from their composition and the textural arrangement of their constituents, and include shapes and orientations of pore spaces. As the source of detrital, the conditions of deposition and the post-depositional digenetic alteration changes with time (gradually or abruptly), and the sedimentary column is built up by a sequence of layers whose boundaries may be sharp or transitional, whose properties may be similar or strongly different to each other. As a result, lithologic units are often interbedded with multiple lithofacies, some of which may be further altered diagenetically, or by interaction with living organisms. Geomaterials are thus heterogeneous at many scales (from micro-textural scale to basin scale), and their properties vary vertically and laterally at many scales.

### SUMMARY

A method for continuous measurement of heterogeneity of geomaterials is disclosed. The method includes identifying a core section from a first well within a field, obtaining the core section from the first well, and obtaining a continuous measurement of the core section. The method further includes overlaying the continuous measurement with a portion of a log response for the first well to obtain an overlay, associating an observation with the overlay to obtain an integrated overlay, and analyzing the integrated overlay to determine a heterogeneity of the core section. The method further includes identifying a location in the core section from which to obtain a sample based on the heterogeneity, obtaining the sample from the core section, and analyzing the sample to obtain an analysis result. The method further includes developing a continuous model for the first well using the integrated overlay and the analysis result and presenting the continuous model.

Optionally, the observation associated with the overlay may correspond to a visual representation of the core section. In this case, the visual representation may be included in the integrated overlay. In addition, analysis of the sample of the core section may include performing discrete measurements on the sample and updating the integrated overlay based on the discrete measurements.

Optionally, additional models may be generated for a number of wells in the field using the method. In this case, a model of the field may be developed based on the model generated for each of the wells.

Other aspects will be apparent from the following description and the appended claims.

### BRIEF DESCRIPTION OF DRAWINGS

FIG. 1 illustrates an example method for continuous measurement of heterogeneity in accordance with one or more embodiments.

FIG. 2 illustrates a graphical representation of continuous measurement of heterogeneity in accordance with one or more embodiments.

FIG. 3 illustrates a graphical representation of fracture characteristics in accordance with one or more embodiments.

FIG. 4 illustrates a graphical representation of continuous strength characteristics in accordance with one or more embodiments.

FIGS. 5-6 illustrate graphical representations of heterogeneity in accordance with one or more embodiments.

FIGS. 7-8 illustrate graphical representations of cluster analysis in accordance with one or more embodiments.

FIG. 9 illustrates a graphical representation of continuous strength characteristics in accordance with one or more embodiments.

FIG. 10 illustrates a computer system in which one or more embodiments of continuous measurement of heterogeneity of geomaterials may be implemented.

### DETAILED DESCRIPTION

Specific embodiments of continuous measurement of heterogeneity will now be described in detail with reference to the accompanying figures. Like elements in the various figures are denoted by like reference numerals for consistency.

In the following detailed description of embodiments of continuous measurement of heterogeneity of geomaterials, numerous specific details are set forth in order to provide a more thorough understanding of continuous measurement of heterogeneity of geomaterials. However, it will be apparent to one of ordinary skill in the art that continuous measurement of heterogeneity of geomaterials may be practiced without these specific details. In other instances, well-known features have not been described in detail to avoid unnecessarily complicating the description.

The systems and methods discussed herein may relate to acquisition of hydrocarbons from an oilfield. It will be appreciated that the same systems and methods may also be used for performing subsurface operations, such as mining, water retrieval, and acquisition of other underground materials.

In general, embodiments of continuous measurement of heterogeneity of geomaterials relate to a method and system for taking continuous measurements of an exposed surface in order to perform analysis of the heterogeneity of the geomaterials. More specifically, determining heterogeneity of geomaterials may include combining continuous measurement of a geomaterial with, but not limited to, quantitative engineering models and techniques of petrologic, geologic and petrophysical analysis to develop accurate models of material properties for heterogeneous materials. Understanding and measuring heterogeneity of geomaterials requires observations and measurements over multiple scales because the representation of heterogeneity changes with scale. By performing continuous measurements of core samples, the core heterogeneity may be related to formation characteristics such as rock texture, fractures, interfaces, petrology, and geology, among others.

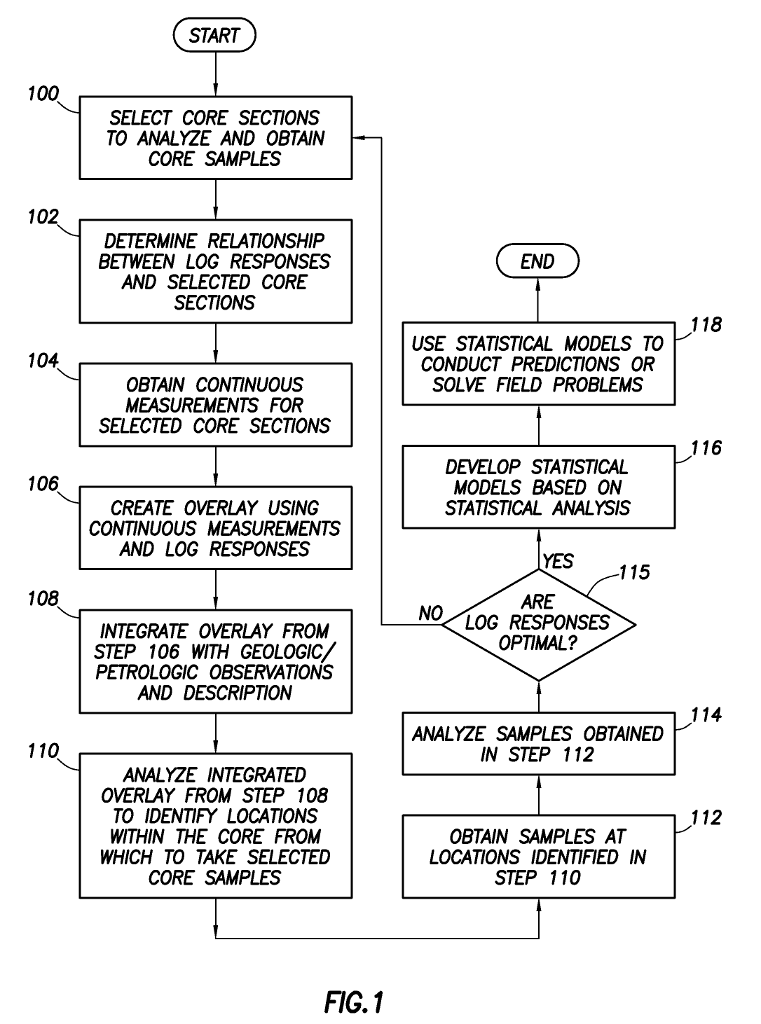

FIG. 1 illustrates an example method for continuous measurement of heterogeneity of geomaterials and sampling in accordance with one or more embodiments. One or more of the blocks shown in FIG. 1 may be omitted, repeated, and/or performed in a different order. Accordingly, embodiments should not be considered limited to the specific arrangements of blocks shown in FIG. 1.

In block 100, the core sections to analyze are selected. In one or more embodiments, core sections may be samples such as: full diameter core samples, slabbed core sections, drill cuttings, rock fragments, sidewall plugs from field well logs (hereinafter “well logs” or “logs”), or material obtained from any other type of exposed surface (e.g., surfaces exposed during mining operations or other drilling operations). The sample sizes can range from a few grains of a material to large laboratory samples, field outcrops and wellbore surfaces. If the sample to be analyzed is not a whole core section, the sample may be in the form of a slabbed core, core sections embedded on a supporting substrate, rock segments embedded on a supporting substrate, side wall samples, rock carvings, or drill cuttings. Core sections are not limited to field wells, and well data is not limited to traditional well logs. Selection of the core sections to analyze may be determined, in part, by data collected from adjacent wells, data collected in the present well, some other factor, or any suitable combination thereof.

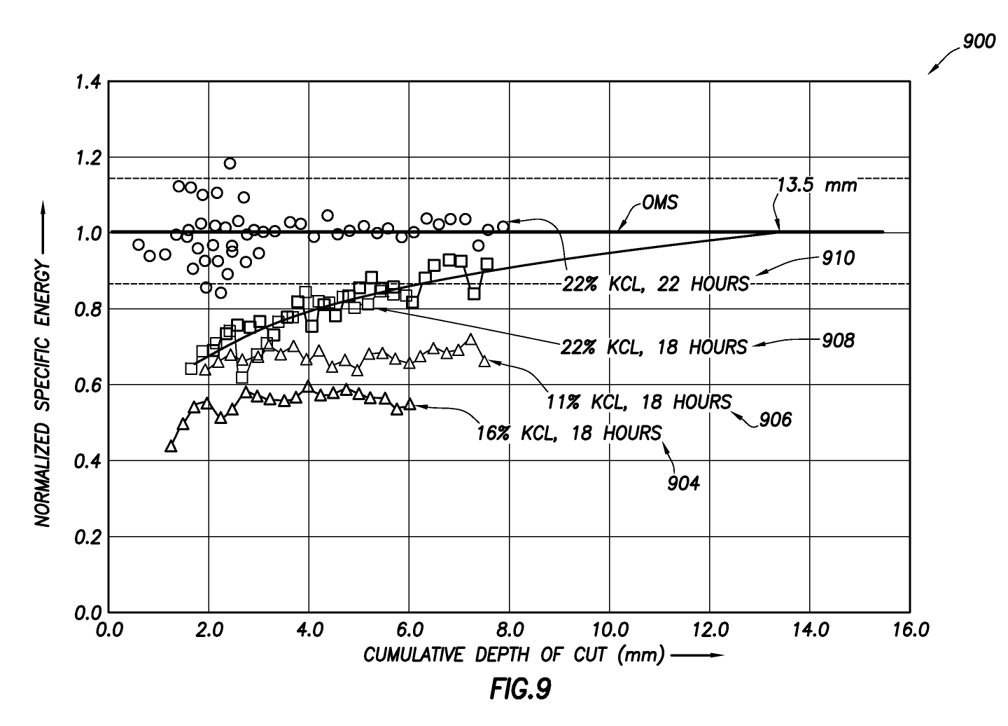

In one or more embodiments, the core sections to be sampled are determined using a cluster analysis of adjacent wells. A description of cluster analysis is provided below. Once the cluster analysis has been performed, the specific core sections may be identified and subsequently obtained when drilling the target well (i.e., the well to which the aforementioned wells are adjacent). In one or more embodiments, a computer, as described with respect to FIG. 10 below, is used to select the core sections to analyze.

In block 102, a relationship is determined between log responses and selected core sections. More specifically, the depth locations at which the core sections were obtained are correlated to the log responses at the same depths. This correlation allows the results of the analysis of the core samples to be compared with the appropriate log responses. Those skilled in the art will appreciate that data collected at multiple scales may be combined to a single reference scale, such as a log scale, for use in the method described herein.

In one or more embodiments, log responses are measurements of properties or behavior (e.g., geologic properties, petrologic properties, reservoir properties, completion properties) of the log. Log responses may be measured in log scale (e.g., defined as one measurement every six inches). Geologic properties may include, but are not limited to, stratigraphic divisions, rock classifications, bed boundaries, lithologic descriptions, fracture descriptions, and others. Petrologic properties may include, but are not limited to, textural composition analysis, mineral arrangement analysis, porosity types, mineral compositions, grain size distribution, cementation, organic content, and others. Reservoir properties may include, but are not limited to, porosity permeability, pore fluid saturations, clay bound water, and others. Completion properties may include, but are not limited to, mechanical properties, elastic static and dynamic properties, strength, and others. The measurements collected on geologic properties may be called geologic data; similarly, the measurements collected on petrologic properties may be called petrologic data. Log response measurements may be gathered through Sonic Scanner (measuring acoustic properties), Elemental Capture Spectroscopy (ECS) (measuring elemental content), Fullbore Formation MicroImager (FMI) (measuring electrical response to produce a borehole image), Modular Formation Dynamics Tester, mud logs, and/or using any other logging tools. Geologic and petrologic data is also gathered for the core section and subsequently used to analyze the relationship with the log response measurements.

Those skilled in the art will appreciate that a cluster analysis may be performed to verify the selected core section(s). More specifically, the analysis may include conducting log measurements and conducting cluster analysis on the log measurements over the cored section. The results of the cluster analysis may be compared with forecasts based on previous measurements at corresponding sections of adjacent wells. If discrepancies exist in the cluster analysis and the previous measurements (e.g., unanticipated faulting), a different core section may be obtained for sampling, as described above in blocks 100 to 102. In one or more embodiments, a computer, as described with respect to FIG. 10 below, is used to determine a relationship between log responses and selected core sections.

In block 104, continuous measurements (i.e., observations or “scratch tests”) are obtained for selected core sections. Continuous measurements may include one measurement or may include several measurements of one or more type along the entire length of the core. In one or more embodiments, prior to performing the continuous measurements, the core is prepared (i.e., processed) and the combination of continuous measurements to be made on the core are selected. Processing may include but is not limited to: depth marking, orientation marking, slabbing, fragmenting, embedding of fragments in a substrate, and surface grinding. Processing may also include gamma ray measurements that determine core-to-log depth relationships, identify lithology, and evaluate shaliness and radioactive mineral deposits. The continuous measurements may be conducted at different scales. For example, the continuous measurements may be conducted at seismic-scale, log-scale, field-scale, well-scale, core-scale, or laboratory sample-scale.

In one or more embodiments, continuous measurements are material properties measurements such as strength, elasticity, isotropic properties, stress properties, fluid interaction, etc. In one or more embodiments, continuous measurements produce high resolution measurements on the core section being measured; however, the resolution may be filtered to a lower resolution. Continuous measurements are not limited to unconfined compressive strength measurement and may be performed on varied shapes and sizes of core sections, or on other samples not in the shape of a core. Continuous measurements may be conducted along any direction in relation to bedding orientation, fracture orientation, or any other textural feature, including radial, axial or transverse orientations. Continuous measurements may be made by a single or multiple longitudinal pass that may be combined with a rotational motion and may be varied as a function of depth of penetration. In one or more embodiments, continuous measurements may also measure volumetric heterogeneity through continuous measurements and removal of material (e.g., on a cylindrical sample by scratching along a helicoidal path) until most of the material is removed and its properties as a function of radial distance from the original surface are measured (with increasing depth of penetration). Topographic reconstructions of these properties provide a high resolution visualization of variability in strength for the entire volume of the sample. Continuous measurements of volumetric heterogeneity may be used for randomly heterogeneous media including, but not limited to, carbonate reservoirs.

In one or more embodiments, the device used to obtain continuous measurements is a stationary or transportable system with a moving head. The moving head may translate and reciprocate across the core section being measured. In one or more embodiments, the moving head may have one or more measuring probes attached with which to measure various properties of the core section. The probes may include: indentor probes, diamond scratch probes, wear probes, light beam probes, rebound probes, acoustic transmission probes, and others. The device may also include supporting frame and mechanisms (e.g., servomechanisms) to facilitate the measurement of the core section. The servomechanisms used to perform the measurements may include axial actuators to control axial stress and load actuators for confining pressure control. The device may also include mechanical devices to control/simulate environmental conditions, such as pads and buffers to create a fluid bath for immersing the sample, or provide control of various other stress conditions including, but not limited to, controlling axial and confining stress, temperature control, exposure to fluids, and various other in-situ conditions. The device may also be configured to obtain continuous measurements under ambient conditions. The device may be stationary, mobile, or hand held and may be used in various applications including, but not limited, to continuous profiling for mining, civil engineering, or in the oil industry. The device may be used in many different situations including, but not limited to, conducting measurements on any outcropping or free surface. For example, in one or more embodiments, the device or methodology may be applicable to the oil industry to perform measurements while drilling or post-drilling, or on rock samples. The device or methodology may be applicable in the mining industry to perform measurements on tunnel walls from mining excavations. The device or methodology may be applicable to the civil engineering industry to perform measurements on extensive surfaces, roads, and compacted areas or in any industry for any outcrop measurement(s).

Continuing with block 104, in one or more embodiments, continuous measurements for a core section may include digital photography and strength measurements to analyze the presence of fractures and interbeds. For example, digital photography provides high resolution evaluation of the texture throughout the core section and strength measurements provide information regarding how strength varies throughout the core section. Combining continuous measurements may provide additional information associated with the presence of fractures and interbeds within the core section. This combination of the photograph with the strength profile may be referred to as an overlay and is discussed in block 106 below. The combination of continuous measurements listed above is an example of a set of continuous measurements that may be performed. Accordingly, embodiments should not be considered limited to the combination of continuous measurements listed above.

Continuing with block 104, an example of continuous measurements that may be performed are continuous strength measurements to calculate ionic diffusivity. To use continuous strength measurements to calculate ionic diffusivity, the core section is exposed to various brine solutions and continuous strength measurements are performed following the exposure. These measurements show the resultant magnitude of chemical interaction in terms of the initial magnitude and depth of penetration for a given time of rock-fluid exposure, thus allowing the calculation of ionic diffusivity. In one or more embodiments, a computer, as described with respect to FIG. 10 below, is used to control the device and/or obtain the continuous measurements for the selected core sections.

In block 106, an overlay is created using the continuous measurements and log responses. Here, the results of the continuous measurements are made visually apparent by overlaying digital photographs of the sample with the continuous measurements. More specifically, the overlay is created by superimposing the continuous measurements over a photograph of the core section being measured, where the superimposed measurement value is directly on top of the point on the sample being measured. If the sample being measured is not a core section but is instead another type of exposed surface, the overlay may be created using a digital photograph of the exposed surface. In one or more embodiments, if the continuous measurements are at core scale and the cluster analysis is at log scale, then one or more relationships may be established between the two scales, allowing for core-log integration.

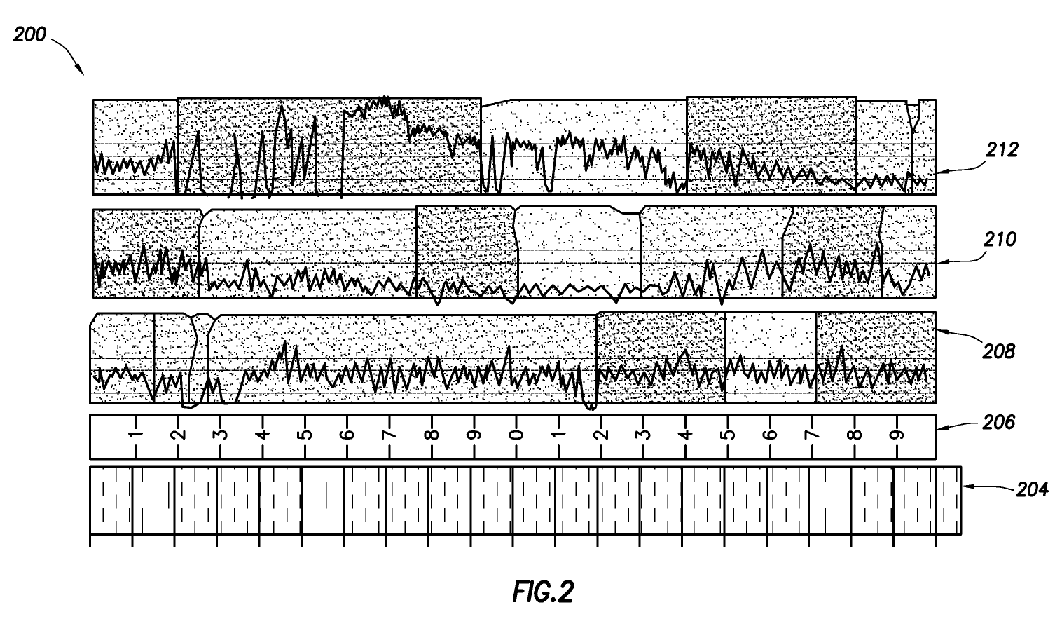

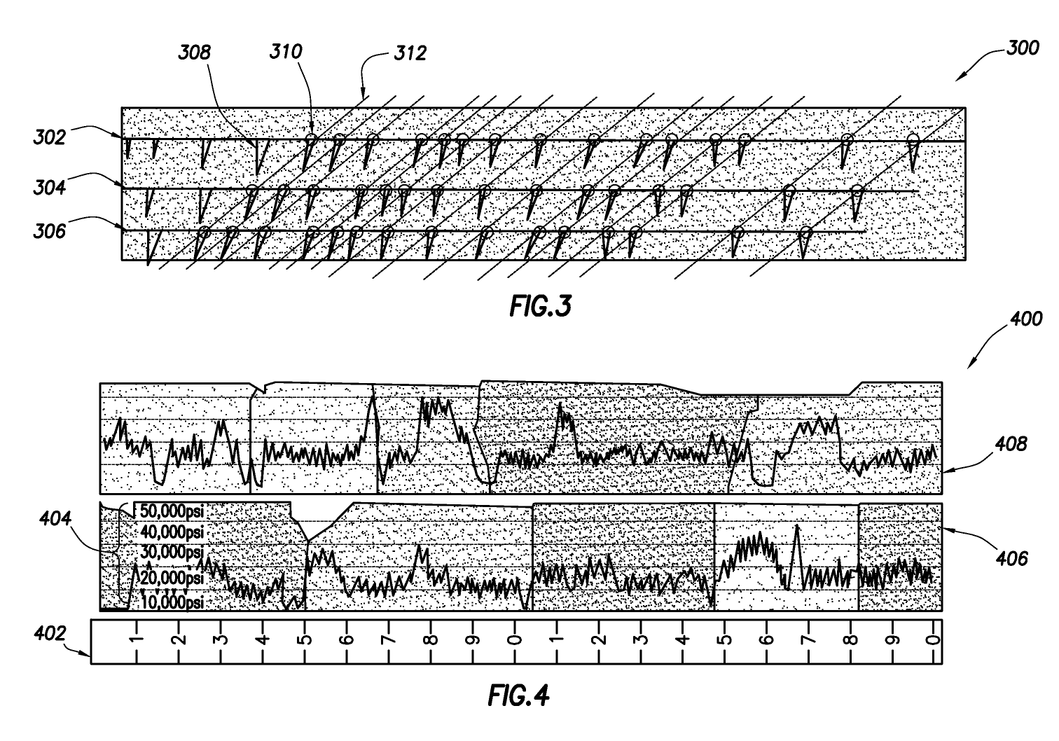

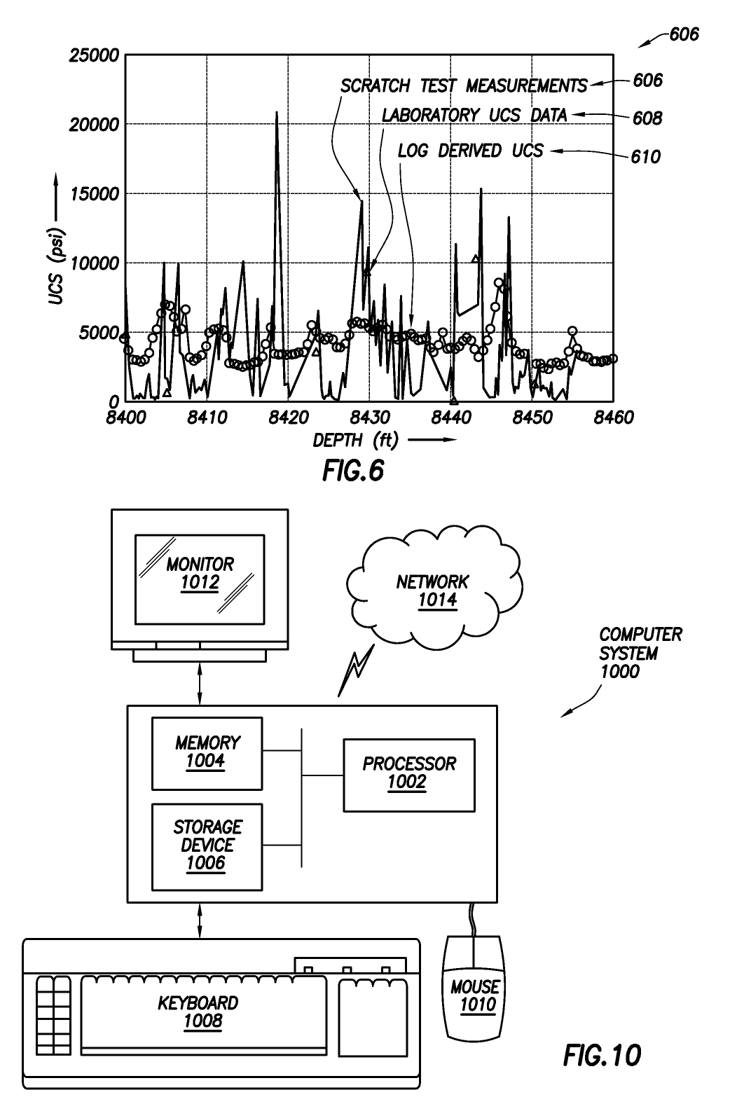

In one or more embodiments, the overlay makes the results of the continuous measurements visually apparent. The visualization allows for direct observations of the relationship between the continuous measurements and the texture, composition, and material properties. For example, measurements of unconfined compressive strength may be overlaid with a digital photograph of a sample to evaluate changes in mineral content, changes in lithological boundaries, quantitative and qualitative geological observations, changes in fracture density, boundaries of interbeds and mineral filled fractures, and variability of mineral content and rock fabric. Examples of some of these measurements are shown in FIGS. 2-5. Continuing with the example, a three cutter head may be used to measure continuous strength profiles allowing the fracture and bedding orientation to be analyzed, as described with respect to FIG. 3 below. The examples of overlays listed above are not meant to be inclusive and those skilled in the art will appreciate that the overlays may take other forms. Analysis of the variability in material properties assists in defining the heterogeneity of the core section and may assist with identifying locations to select additional samples, as described with respect to FIG. 5 below. The selection of additional samples is discussed further in block 110. In one or more embodiments, a computer, as described with respect to FIG. 10 below, is used to create the overlay using the continuous measurements and log responses.

In block 108, the overlay from block 106 is integrated with geologic and petrologic observations and descriptions. Geologic and petrologic observations and descriptions may include quantitative or qualitative data. Examples of geologic and petrologic observations and descriptions include, but are not limited to, structural observations, rock and mineral specific observations, and fracture descriptions. The overlay may also be integrated with a visual representation of the core section. This data may be integrated with the overlay by adding an additional code at the bottom of the overlay that details the geologic and petrologic data. The code may be implemented with colors or numbers for graphical evaluation. The integration may reveal further details regarding visual observations of textural changes, composition changes and corresponding changes in material properties. Integrating the visually apparent results with geologic/petrologic observations and descriptions allows for further evaluation of the sample for consistency through direct visual observation of texture, composition, and material properties. The integration may be used to develop core-to-log scaling relationships and for integrating the analysis-to-log scale heterogeneity, based on a particular well (described below in block 116).

In one or more embodiments, in block 108, continuous measurements may be used for further evaluation after integration, such as: evaluation to measure fracture characteristics (e.g., fracture density and fracture orientation (dip and azimuth)) to compare with corresponding core fracture and log fracture analysis; analyzing the location, frequency and strength of interbeds; analyzing the relationship between specific rock types and strength; and evaluating the thickness of finely-resolved thin beds for sedimentologic analysis. Further, in block 108, the continuous measurements may be filtered to log resolution (i.e., two measurement points per foot) to create another representation of the measurement to be used in the overlay. This analysis may be used to identify locations within the core from which to obtain selected core samples (described in block 110). In one or more embodiments, a computer, as described with respect to FIG. 10 below, is used to integrate the overlay with geologic and petrologic observations and descriptions.

In block 110, the integrated overlay from block 108 is analyzed to identify locations within the core from which to obtain selected core samples. In one or more embodiments, the integrated overlay is analyzed to identify selected core samples (i.e., additional samples) that may undergo additional analysis to more accurately characterize the properties of the homogeneous medium or the properties of the various constituents of the heterogeneous medium. Those skilled in the art will appreciate that the selected core samples may be laboratory samples. The core samples may be selected using the integrated overlays and statistical analysis (e.g., cluster analysis, analysis of variability in log responses or variability in continuous measurements, etc.). Discrete measurements may be collected from these selected core samples based on the variability of the continuous measurements. In this case, the analysis better characterizes the core section's geologic and petrologic properties. For example, if the analysis in block 110 reveals that the core section is homogenous (or substantially homogeneous), then there may be no need to obtain additional samples. However, if the analysis reveals that the core section is not homogeneous (or substantially heterogeneous), then additional samples from within the core section may be obtained for analysis, to determine the extent of heterogeneity within the core section and properties associated with each of the heterogeneous sections within the core section.

In one or more embodiments, the analysis of the integrated overlay may include re-interpreting or confirming geologic interpretations. For example, it may be possible to perform a quantitative analysis of heterogeneity on an integrated overlay to determine locations of selected core samples. In another example, it may be possible to perform a quantitative analysis of heterogeneity on an integrated overlay to determine the massive and bedded sections of a sample. In this case, the sections may then be used to define the selected core samples used for additional testing.

In another embodiment, the quantitative analysis of heterogeneity may be compared with log predictions of strength to determine the locations of the selected core samples. In this case, the higher resolution of the continuous strength measurements may be used to identify low strength areas not identifiable through the log predictions, as described with respect to FIG. 6 below. These low strength areas may indicate that additional analysis should be performed because of an increased risk of sanding. This additional analysis may be performed by obtaining selected core samples from those areas identified by the continuous measurements for additional analysis.

In one or more embodiments, statistical analysis may be used to identify locations within the core from which to obtain selected core samples. An example of statistical analysis that may be used with the continuous measurements performed in block 104 is ternary diagrams. Ternary diagrams are visualizations that help characterize similarities in the composition of the material by discriminating three dominant groups of minerals (ternary diagrams are not shown). When these dominant groups of minerals are combined with a contour map of the continuous measurements (e.g., strength), the result may show graphically that many samples with similar composition have similar strength. This similarity indicates that composition is the primary control of this property (possibly because the texture is invariant). Alternatively, if samples with the same composition show considerable variability in strength, this variability suggests that composition alone is not the driver of strength. In such a case, textural observations (e.g., grain size, shape, and grain size distribution, micro-bedding, or alternate combinations of beds with different grain size that give rise to a laminated texture) are performed. These observations are coded (with colors or numbers) for graphical evaluation. Combining the two observations (texture and composition) in the same ternary diagram provides a visually apparent means to understand how the combinations of composition and texture may result in similar or dissimilar strength. In one or more embodiments, these results may be incorporated into a model that relates the continuous measurements to the geologic and petrologic measurements of texture and composition (discussed in block 116).

Those skilled in the art will appreciate that further testing may be useful to characterize other properties of the core section. Such further testing may include creating subsequent overlays based on the results of the further testing. Once the analysis in block 110 is completed, the locations to obtain the selected core samples are defined. These selected core samples often provide discrete measurements to more accurately characterize the material properties of an area of interest. Also, if groups of core samples are analyzed for specific material property characterization (e.g., for failure envelope analysis based on 5 triaxial tests at multiple levels of confinement), then the selection of core samples defined in block 110 may provide a high certainty that the samples are representative of each other (i.e., the core samples are properly grouped). This certainty is verified because the selected core samples are defined based on the statistical analysis performed in block 110. The statistical analysis is used to ensure adequate representation of the variability of the core, log, and/or well heterogeneity. The models created to characterize material properties of an area of interest are discussed in block 116. In one or more embodiments, a computer, as described with respect to FIG. 10 below, is used to analyze the integrated overlay to identify locations within the core from which to obtain selected core samples.

In block 112, the samples identified in block 110 are obtained. In one or more embodiments, the analysis from block 110 may first be sent to a client for approval prior to obtaining the samples. The samples may be obtained from within the core section being analyzed (e.g., plugged from the core section). The samples may be obtained based on prior analysis. In one or more embodiments, a computer, as described with respect to FIG. 10 below, is used to control equipment to obtain the identified samples.

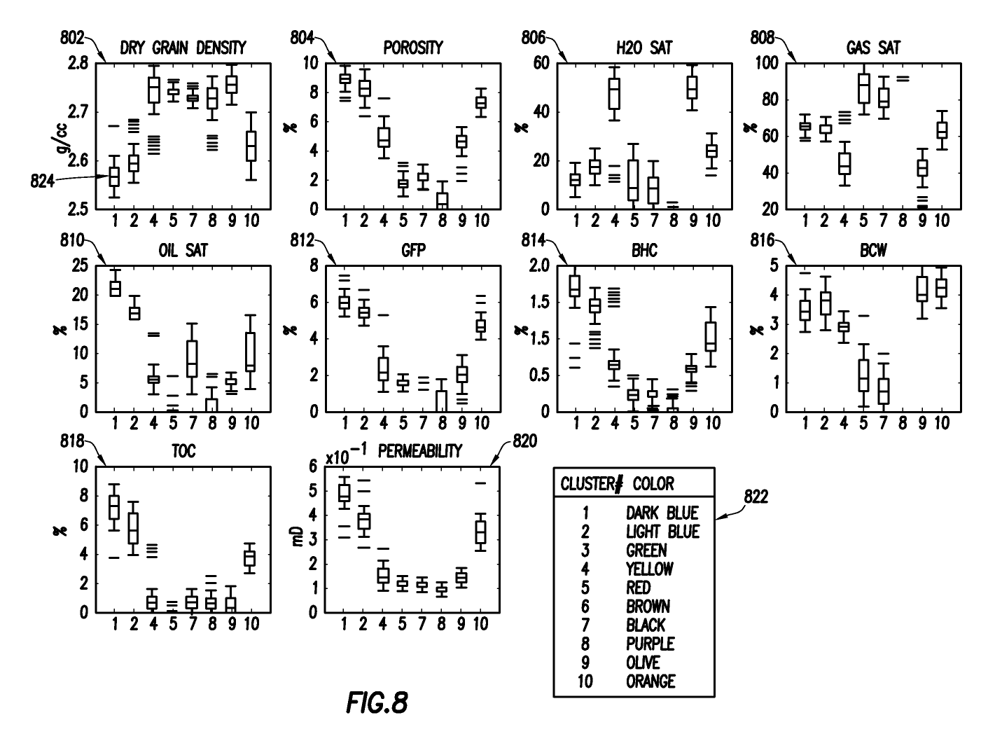

In block 114, the samples obtained in block 112 are analyzed. For example, the analysis of the samples may occur in a laboratory. Further, the analysis of the samples may result in a complete evaluation of the heterogeneous core. In one or more embodiments, the analysis includes performing discrete measurements such as elemental analysis, stress, fluid penetration, and others. As discussed previously, these discrete measurements are used to obtain an adequate representation of the variability of core, log, and/or well heterogeneity. These discrete measurements provide additional measurement values to supplement the continuous measurements performed in block 104 and the analysis performed in block 110. In such cases, the sample analysis is used to accurately characterize unknown areas of heterogeneity identified in block 110. More specifically, the analysis of the samples may produce information related to reservoir, petrologic, geochemical, mechanical, and other properties of the core, as described with respect to FIG. 9 below. The analysis may then be used to create models to predict behavior of other areas with similar geologic and petrologic properties. In one or more embodiments, a computer, as described with respect to FIG. 10 below, is used to analyze the samples.

In block 115, a determination is made as to whether the log responses are adequate. If the log responses are adequate (i.e., sufficiently sensitive), the process proceeds to block 116. If the log responses are not adequate, then the process reverts to block 100. If the results from laboratory testing of the samples confirm that units with the same cluster definitions, regardless of location in the core, result in statistically similar laboratory measurements (e.g., as described below in FIG. 8), then the cluster analysis is validated (i.e., adequate). If not, as the process reverts to block 100, the cluster analysis may be evaluated and modified, such as by adding additional log channels and taking new measurements. In one or more embodiments, a computer, as described with respect to FIG. 10 below, is used to determine whether the log responses are adequate.

In block 116, statistical models are developed based on the statistical analysis. The statistical models may be continuous, discrete, or a combination thereof. In one or more embodiments, the statistical models are developed on a per-cluster basis using the continuous measurements (block 104), the analysis of the integrated overlay data (block 110), and the discrete measurements obtained from the sample analysis (block 114). This data is analyzed to create statistical distributions of the measurements to characterize representative variability of the measured properties and the log responses defining the individual cluster units. Using these statistical distributions, models are created that predict values of each measured property along the entire logged section, which includes the cored section, to obtain a set of predicted values for the material along the length of the logged section.

Continuing with block 116, scaling may be used to relate the core measurements to log responses. Scaling uses cluster units correlated with patterns of log responses to relate these with small scale petrologic measurements. Scaling may be performed based on a defined reference scale (e.g., cluster analysis at log resolution). For example, upscaling may be performed from smaller scales to the reference scale, using statistical methods. In another example, downscaling may be performed from larger scales to the reference scale, or from the reference scale to a smaller scale, using pattern recognition or self adapting statistical algorithms. Thus, scaling petrologic data to well log data includes defining cluster units with characteristic combined log responses representing characteristic material properties. For example, the high resolution continuous measurements performed in block 104 may be used to perform a statistical analysis of the variability of the measured property or properties, along the length of the particular cluster. An output of the statistical evaluations may be the box-and-whisker plot representation, where the box is defined by a mean value and the upper and lower quartiles of the data (two standard deviations). The whiskers include the rest of the data. Thus, distributions with short boxes represent almost constant values, and distributions with long boxes represent large variability in the measured data. Statistical distributions of reservoir properties using a cluster analysis is described below with respect FIG. 8. After the cluster analysis is conducted along the core section, the clusters, as they relate to the variability of log responses, are applied to other sections of the log. This process is referred to as cluster tagging. The compliance between the combined log responses and the other sections of the log are quantified by an error function to determine locations of low compliance. The locations of low compliance are not represented by materials sampled in the core section.

The method to perform scaling with geological measurements uses the descriptive (non quantitative) nature of geology, and as such is different than the quantitative analysis described above. However, when provided with the continuous measurements and the overlay of continuous measurements and digital core photography, geologists may be more specific and consistent in their descriptions and the descriptions therefore become more quantifiable. For example, a coarsening upward sequence due to the observation of the gradual increase in grain size in a rock section indicates a measurable trend of increasing strength, where one can measure the upper and lower values and the length of the sequence using the continuous measurements overlaid with the digital core photography. In one or more embodiments, a computer, as described with respect to FIG. 10 below, is used to develop the statistical models.

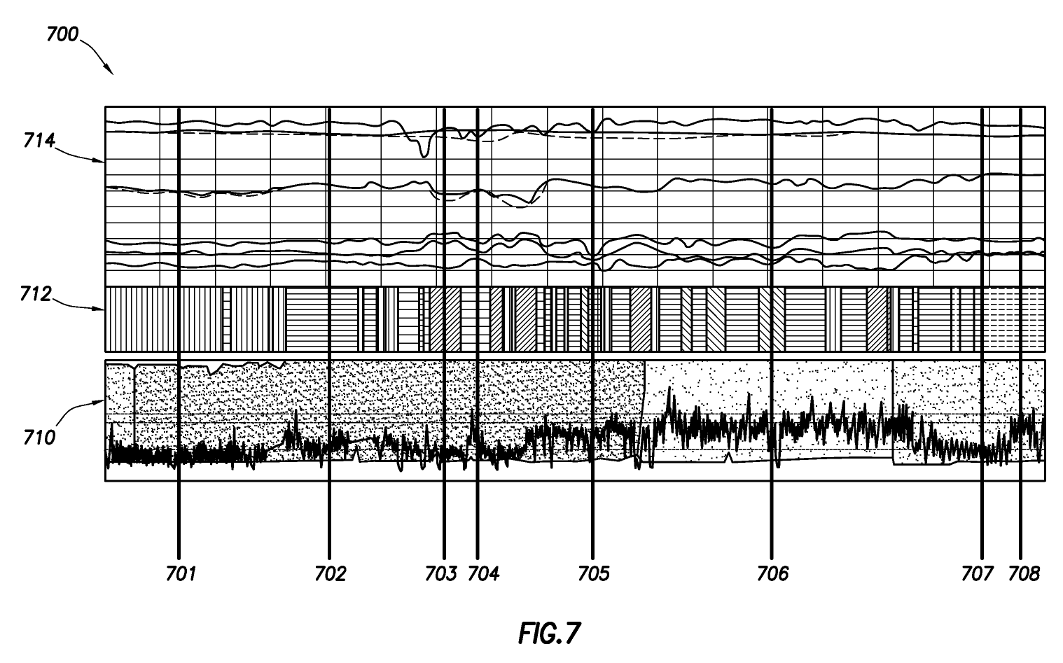

In block 118, the statistical models may be used to conduct predictions or to solve field problems. In one or more embodiments, the predicted values from the models created in block 116 are compared with results from the discrete measurements performed in block 114. The predicted values may also be compared with results of the continuous measurements performed in block 104, when possible. The data from these comparisons is used with cluster tagging methodology to assign an index of reliability to the predicted values. The index of reliability identifies clusters outside the core that are identical to clusters existing in the core and such clusters are given high compliance ratings. Conversely, the clusters outside the core that do not compare well with clusters existing in the core are given low compliance ratings. Therefore, predictions with high reliability correspond to cluster units with high compliance ratings. A graphical depiction of these comparisons is described below with respect FIG. 7. In one or more embodiments, a computer, as described with respect to FIG. 10 below, is used to run the statistical models and provide output based on the results.

In the case where a core section was obtained from a well and, after laboratory testing, statistical models relating core data to log data were obtained, the statistical models developed in block 116 may be used to conduct predictions on subsequent adjacent wells using logs from the adjacent wells. In this case, the adjacent well logs may be analyzed using the cluster analysis discussed above using the log definitions for clusters identified in the reference well (i.e., the well from which the core section measurements were obtained and analyzed). The results of the cluster analysis may then be used along with an analysis of predicted values for properties to obtain predictions of the material property of the adjacent well based on the previously developed model.

The following is an example of using the statistical models developed in block 116 to solve field problems. In such cases, the statistical models may be used to flag rock units with distinct material properties using log measurements. Cluster analysis is used to evaluate the rock units. The resulting log derived mineral and composition relationships are evaluated using the model developed in block 116 to identify one or more of the aforementioned rock units as having characteristic properties or behavior (e.g., elastic versus non-elastic behavior, isotropic versus anisotropic properties, stress dependent versus stress-independent behavior, fluid sensitive versus non fluid sensitive behavior, etc.).

In one or more embodiments, the statistical models created in block 116 may be used to flag behavior of material properties using logs. In this scenario, log responses may be measured and cluster analysis performed to determine distinct material properties of the log. The log responses may be evaluated based on the clusters identified/derived from continuous measurements to determine log areas with characteristic properties. These areas may be flagged to identify areas with similar material properties.

The statistical models created in block 116 may also be used to solve problems in the field of well drilling. For example, predictions of strength along the core, discrete measurements, and continuous measurements may be combined to identify areas prone to sanding, as described with respect to FIG. 9 below. In this example, the log predictions provide a good representation of the average strength but may not accurately identify specific low strength areas. The continuous measurements may be used to identify the specific low strength areas accurately within the core sections and to help predict low strength areas in other portions of the well. Specifically, integrating the log responses with the continuous measurements on the core may result in a more accurate model capable of identifying the low strength areas and predicting their presence outside the core section.

Another example of a problem that may be solved using the statistical models created in block 116 is fluid-rock interaction. Fluid-rock interaction is difficult to measure and quantify; however, it is possible to evaluate this relationship by identifying the ionic diffusivity constant of a core section (or sample thereof). In this example, samples are immersed in an inert fluid for a set length of time and then they are submitted to repeated continuous strength measurements until the depth of an altered area (i.e., the invasion area) is located. The decrease in strength after immersion may be evaluated from the measurements. In addition, the rate of ionic diffusion may then be evaluated from the measurements. Strength reduction as a function of time of exposure to fluids and calculating the ionic diffusivity provides an accurate model of potential fluid-rock interactions.

In one or more embodiments, the actions performed in blocks 102 through 110 may be automated and performed using a device. The device may be connected to a computer system running a software program to conduct the aforementioned analysis to determine the relationship between the log responses and selected core section (block 102), to obtain the continuous measurements (block 104), to create the overlays of continuous measurements with log responses (block 106), integrate the overlays with geologic/petrologic observations and descriptions (block 108) and analyze the integrated overlays to determine selected core samples (block 110). In this example, the samples may be obtained by the device in an automated fashion. In this case, the device may perform an initial pass of the core section to perform the continuous measurements and then perform a second pass of the core section to plug the samples identified in block 110. Also, while plugging, the device may perform additional measurements of torque, rate of penetration, etc. These additional measurements may be used for subsequent comparison and analysis, and to identify sample quality.

Consider an example of a process for automated sampling, as described in the preceding paragraph. Initially, the results of a cluster analysis are obtained. Then, the clusters within the interval where the core exists are evaluated, as are the top and bottom core depths associated to the boundaries of each cluster. Next, outliers of the cluster data are removed. At this stage, the ratio of the combined length of the cluster units with the same color (i.e., cluster group) to the total length of the core is calculated. In addition, a second ratio is calculated by dividing the length of the core equally by the number of clusters. Then, the degree of dominance of each cluster group is evaluated using the two ratios previously calculated. The most dominant clusters and the standard clusters may receive a sampling redundancy (i.e., the degree of replication) of 2, and the least dominant clusters may receive a sampling redundancy of 0.5.

Next, after saving the results of the high resolution continuous measurements on the core, the statistical frequency distributions of each of these measurements is calculated on a cluster-by-cluster basis. Then, the individual statistical distribution for each of these individual clusters of the same designation is compared to the combined variability for other sections with the same cluster designation. Next, if the statistical distributions of clusters of the same designation located in different sections of the core result in bi-modal or-tri-modal distributions, a warning for re-clustering is triggered. When multiple continuous core measurements are evaluated, they are given a weighting factor (as manually assigned or as determined based on internal experience associated to previous completed projects) of their importance in the analysis. Optionally, a box-and-whisker plot of the combined statistical distributions for each cluster color may be presented.

Continuing with the example, the variability between the median value of the entire distribution and the median value of the first and third quartile of the distribution (which corresponds to the percent variability between the median value and the edges of the box plot) is calculated. Then, the variability between the median value of the first and third quartile of the distribution and the maximum and minimum values of the distribution (which corresponds to the percent variability between the edges of the box plot and the whiskers of the distribution) is calculated. At this stage, sampling coefficient factors defined based on previous experience are compared with corresponding threshold values for each of these two prior calculations, and the results are added to obtain the final number of samples per cluster. Next, the number of samples needed per cluster are consolidated, and the sampling redundancy coefficient (described above) is applied to determine the total number of samples needed per cluster designation. Then, other corresponding locations in the core associated to the desired property values for each cluster are selected.

Still continuing with the example, other possible locations for the desired values to the log responses are compared based on criteria such as minimum hole enlargement, best quality log data, and minimum variability in the log data to within some distance of a selected point. The candidate points not meeting the criteria may be eliminated. Next, the remaining points are compared with the continuous core measurements, and those that exist in a range of stable values within a defined distance of the selected point are retained. These remaining points are considered high quality and are presented as highlighted on a cluster by cluster level. Then, final locations for sampling are recorded in a sample selection log and overlaid to plots displaying logs, core images, and continuous measurements. Next, samples along each of the desired locations are obtained. When drilling samples, measurements of torque, weight on bit, and depth of penetration of the sample to the coring barrel are used to identify sample quality. If the sample quality is acceptable, the operation continues to the next location. If the sample quality is rejected, the best equivalent sample from the list is chosen. Once the samples are obtained as desired, the operation is completed.

Those skilled in the art will appreciate that continuous measurement of heterogeneity of geomaterials may integrate methods of cluster analysis and cluster tagging used for defining heterogeneity at a log-scale with methods to provide quantitative assessments of heterogeneity of material properties at a core-scale. In this case, the continuous measurements and profiles of material properties obtained on core or rock samples are related to continuous measurements and profiles (i.e., well logs) obtained from wells. This integration of log-scale and core-scales via cluster analysis allows for better selection of well locations for coring, core sections or side wall plugs, and better sampling and characterization of cluster units. In addition this integration of log-scales and core-scales via cluster analysis results in more accurate development of models between cluster units (defined at log resolution), and measured continuous and discrete material properties.

In one or more embodiments, cluster analysis may be performed on the continuous measurements performed in block 104. The cluster analysis may correspond to a statistical multidimensional analysis that partitions data into subsets, each of which share a common trait. In other words, the results of the continuous measurements are partitioned into groups where the results in each group share a common trait or set of measurements. In particular, cluster analysis may identify rock units with similar and dissimilar combined log responses. These similar groups are then defined as clusters. The results of cluster analysis may represent clusters using colors, where similar colors identify areas with similar material properties. Cluster analysis is beneficial because it sets a common reference for evaluation of material properties by many disciplines, including but not limited to geology, petrology, geophysics, and laboratory characterization. Cluster analysis is also beneficial because the analysis may show heterogeneity at log scale or sub-log scale, the analysis discriminates areas of consistent clay behavior within a heterogeneous area and models calibrated using a core at the cluster level may be more robust.

In one or more embodiments, the cluster analysis may be used in block 110 in combination with the analysis of the integrated overlays to select locations in the sample. More specifically, the selection of locations within the core section may be performed based on the cluster analysis, analysis of variability in log responses within each cluster, analysis of variability of many continuous measurements conducted on the core section, and/or visual variability of core texture. For example, FIG. 7 depicts eight samples selected to optimize the representation of the different clusters. The cluster analysis may also be analyzed to determine proper sampling required to adequately represent each cluster.

Further analysis of the clusters may provide a better understanding of additional samples that may assist in properly characterizing the geologic and petrologic properties of the core sample for each cluster. This further analysis may be performed by creating statistical distributions of the continuous measurements on a per cluster basis. Different clusters often exhibit different distributions of the same property. These results may be used to evaluate the locations chosen within the core sample to obtain the selected samples for further laboratory testing.

For example, the cluster analysis may include displaying results to identify core sample selections. In one or more embodiments, the continuous measurements are filtered to their equivalent log resolution to overlay them with the representation of the cluster analysis. The result is a visually apparent display for selection of discrete samples for laboratory testing. Additionally, the information provided by the continuous measurements with digital image overlays, the continuous measurements, the cluster analysis overlays, and the statistical distributions of the continuous properties for each cluster, may be compared to define the number and location of laboratory samples. Cluster analysis is also described below with respect FIGS. 7 and 8.

FIG. 2 illustrates a graphical representation of continuous measurement of heterogeneity of geomaterials. The graph 200, in this example, displays continuous properties (e.g., unconfined compressive strength) to define geologic parasequences (e.g., coarsening upward sequences). Analysis using this graph 200 provides quantitative measurements for qualitative geologic observations.

The graph 200 includes a core geologic log 204 as well as a scale 206 associated with various continuous scratch tests of one or more core samples 208, 210, 212. In this example, the core geologic log 204 reflects different mudstone lithofacies identified during a visual geologic inspection of the sample. The scale 206 is divided into tenths of a foot, reflecting that the core sample is two feet long. In this example, the various continuous scratch test measurements (i.e., continuous measurements) of the one or more core samples 208, 210, 212 indicate the magnitude of the unconfined compressive strength (UCS), reflected in pounds per square inch (psi), throughout the length of the core. In another example, the various continuous measurements of the one or more core samples 208, 210, 212 may also indicate acoustic velocity, surface hardness, rock color, rock-fluid interaction, any other continuously measured properties, or any combination thereof. In addition, the continuous scratch test measurements of the one or more core samples 208, 210, 212 are superimposed (i.e., overlayed) with an image (e.g., a digital photograph) of the corresponding core sample being measured, where superimposed measurement value directly corresponds to the point of the core sample being measured.

As explained above, a benefit of overlaying the scratch test with an image of the corresponding core sample is to allow for direct observations of the relationship between texture, composition, and material properties of the corresponding core sample. The various continuous scratch test measurements of the one or more core samples 208, 210, 212 may be the same test for different core samples, different tests for the same core samples, or any combination thereof.

FIG. 3 illustrates a graphical representation of fracture characteristics in accordance with one or more embodiments. Specifically, FIG. 3 illustrates a graphical representation of continuous strength profiles for a three cutter head. Plot 302 of the graph 300 represents the direction of movement of the left cutter as the cutter performs a scratch test along the core sample; plot 304 represents the direction of movement of the center cutter as the cutter performs a scratch test along the core sample; and plot 306 represents the direction of movement of the right cutter as the cutter performs a scratch test along the core sample. The graph 300 may undergo filtering to eliminate low amplitude variability. Analysis of the measurements in the plots 302, 304, and 306 provides information regarding the fracture and bedding orientation. The downward spikes (e.g., 308) on each of the plots 302, 304, and 306 represent a marking of a feature. For example, downward spike 308 may represent a marking of a fracture or some other discontinuity (e.g., 312) in the core sample. In this example, the circles over these spikes (e.g., 310) may represent the results of the analysis and the alignment of the measurements to identify the azimuthal orientation of the feature. Further, as the center cutter cuts at increased depths, additional information regarding the fracture and the bed dip may also be obtained. As shown in this example, an overlay of the direction of movement of each cutter head with an image of the core sample may allow for direct observations of the fracture and bed dip.

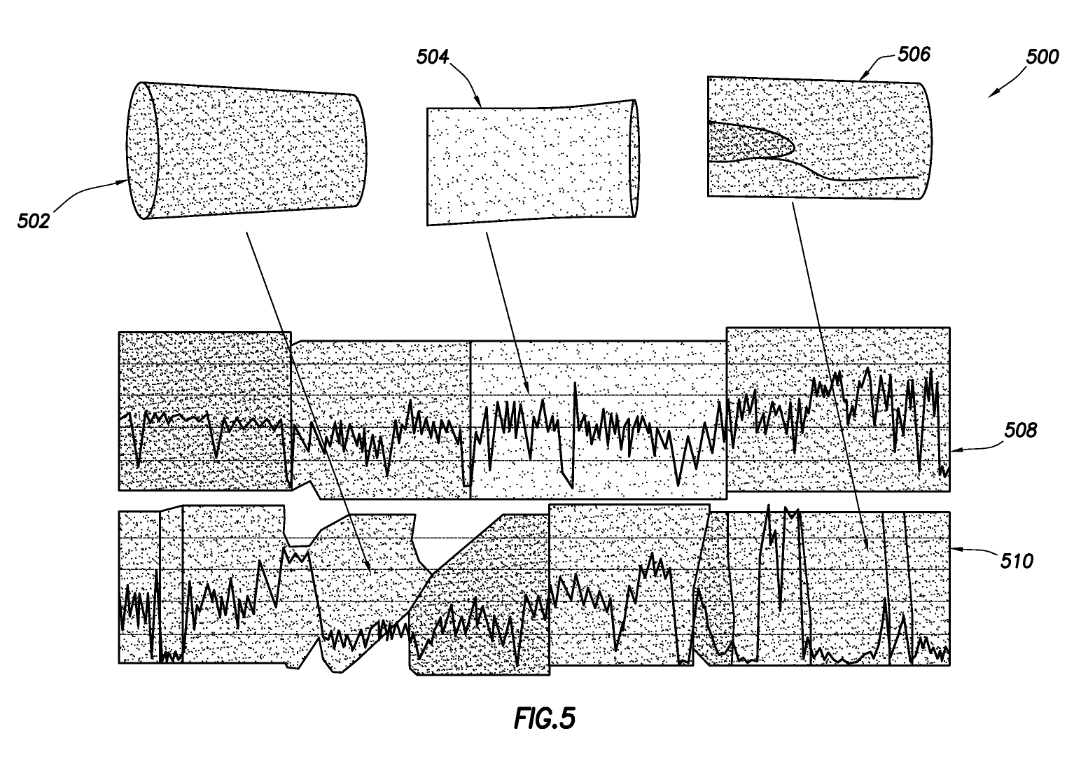

FIG. 4 illustrates a graphical representation of continuous properties in accordance with one or more embodiments. Specifically, the graph 400 shows the magnitude and frequency of the strength variability to determine variability in mineral content and rock fabric of the core sample. The graph 400 has a length scale 402 in tenths of a foot and a stress scale 404 in increments of 10,000 psi. The stress scale 404 is associated with various continuous scratch tests of one or more core samples 406 and 408. The various continuous scratch test measurements of the one or more core samples 406 and 408 indicate the magnitude of the unconfined compressive strength (UCS) throughout the length of the core. The various continuous scratch test measurements of the one or more core samples 406 and 408 may be the same test for different core samples, different tests for the same core samples, or any combination thereof. As shown in this example, an overlay of the scratch test measurements with an image associated with the one or more core samples 406 and 408 may be used to make the continuous strength measurements visually apparent, allowing for direct observations to be made and compared between the core samples 406 and 408. For example, the continuous strength measurements may be analyzed in the context of the overlay to understand the variability of other associated properties (e.g., permeability, porosity, etc.)

FIG. 5 illustrates a graphical representation of heterogeneity (i.e., variability in material properties) in accordance with one or more embodiments. The graph 500 shows an image of each of three different core samples (sample A 502, sample B 504, and sample C 506) taken in a laboratory. The images show that each of the three core samples 502, 504, 506 is generally cylindrical in shape. In this case, each of the core samples 502, 504, 506 has dimensions of approximately one inch in diameter by two inches in length. Each core sample 502, 504, 506 is depicted as an actual rock sample and included in a quantitative analysis of heterogeneity (i.e., variability in material properties). Continuous scratch test measurements are shown in 508 and 510. The results of the continuous scratch test measurement (in terms of unconfined compressive strength) for Sample B 504 is shown in the center portion of continuous scratch test measurement 508. The results of the continuous scratch test measurement (in terms of unconfined compressive strength) for Sample A 502 and Sample C 506 are shown in the left and right portions, respectively, of continuous scratch test measurement 510. Core samples measured in a laboratory may be selected along representative sections of core sample variability, based on characteristics such as rock type and strength. In one or more embodiment, performing continuous measurements on each of the core samples 502, 504, 506 reveals variations in the measurements. Based on these variations, zones that have similar properties may be determined, allowing test samples that represent each of the different zones to be selected to better analyze the heterogeneity of the core.

FIG. 6 illustrates a graphical representation of unconfined compressive strength for determining heterogeneity in accordance with one or more embodiments. Specifically, FIG. 6 demonstrates the effectiveness of the continuous measurement of heterogeneity of geomaterials. The graph 600 plots three different measurements. Specifically, the graph 600 plots scratch test measurements 606, discrete data measured in a laboratory 608, and evaluation of rock strength from a log measurement 610. The scratch test measurements 606, which are continuous strength measurements, provide a much higher resolution and indicate that the sample is much more heterogeneous than disclosed by the laboratory 608 and log measurements 610. In this example, the discrete data measured in a laboratory 608 coincide with the scratch test measurements 606, which demonstrates the validity of the scratch test measurements 606 in determining the actual homogeneity of the core sample. By contrast, the evaluation of rock strength from a log measurement 610 shows a high degree of variability compared to the scratch test measurements 606, indicating that the evaluation of rock strength from a log measurement 610 fails to correctly reflect the actual homogeneity of the core sample.

FIG. 7 illustrates a graphical representation of a cluster analysis in accordance with one or more embodiments. The graph 700 includes eight different cluster groups 701-708, where each cluster group corresponds to a hatching configuration displayed on the cluster graph 712. Although each cluster group corresponds to a number in this example, each cluster group may also correspond to a color. A hatching configuration on the cluster graph 712 represents a depth where the characteristics corresponding to the cluster group of that hatching configuration are more prevalent than the characteristics corresponding to the other cluster groups. The continuous measurement produced by a scratch test on the core sample 710 shows variability along the length of the core sample 710 in terms of psi. The scratch test measurement of the core sample 710 may be overlayed with an image of the core sample 710. Log responses within each cluster (e.g., 714) are also shown along the length of the core. An analysis using these results may allow for a user to identify potential candidates for subsequent core sample selections. As explained above, by filtering the scratch test measurements to their equivalent log resolution and overlaying them with the results of the cluster analysis (i.e., combining high and low resolution data to find discrepancies between heterogeneity and homogeneity), subsequent core sample selections may be identified.

FIG. 8 illustrates a graphical representation of a cluster analysis in accordance with one or more embodiments. More specifically, FIG. 8 illustrates a series of box and whisker plots (e.g., 802-820), each representing a continuous predicted property (e.g., dry grain density, porosity, etc.) on a cluster-by-cluster basis. A legend 822 specifies a designation for each cluster represented in the box and whisker plots (e.g., 802-820). The consistency of the clusters in representing unique sets of properties is assessed based on the size of the box plots (e.g., 824). The smaller the size of the box plot, the narrower the distribution, which indicates a higher degree of confidence in the assessment of that property in that cluster.

FIG. 9 illustrates a graphical representation of continuous strength measurements on cylindrical core samples for evaluation of rock-fluid sensitivity, in accordance with one or more embodiments. The graph 900 plots measurements in terms of normalized specific energy relative to a depth of cut in the core sample, where the core sample is immersed in an inert fluid. In this example, the fluid contains a concentration of potassium chloride (KCl). After immersion of the core sample in the fluid for a set length of time, repeated continuous strength measurements are conducted until the depth of the invasion zone is located, where the invasion zone is the depth that the fluid has penetrated the core sample. The depth of penetration of the invasion zone and the rate of ionic diffusion can be evaluated from the measurements. The graph 900 includes a reference plot 902 for a continuous measurement conducted without immersing the core sample in a fluid. Further, the graph 900 shows four plots for continuous measurements conducted after immersing the core sample in KCl of a variety of durations and/or concentrations (904-910). The first plot 904 shows measurements performed on a core sample after being immersed in 16% KCl for 18 hours. The second plot 906 shows measurements performed on a core sample after being immersed in 11% KCl for 18 hours. The third plot 908 shows measurements performed on a core sample after being immersed in 22% KCl for 18 hours. The fourth plot 910 shows measurements performed on a core sample after being immersed in 22% KCl for 22 hours. The fourth plot 910 also includes a best fit line indicating that the depth of penetration of the altered zone is 13.5 mm. In this case, the ionic diffusivity constant for the fourth plot 910 is evaluated to be 2.3×10⁻³ m²/s.

Those skilled in the art will appreciate that the previous examples described with respect to FIGS. 2-9 are provided for representative purposes only and accordingly should not be construed as limiting the scope of continuous measurement of heterogeneity.

Embodiments may be implemented on virtually any type of computer regardless of the platform being used. For example, as shown in FIG. 10, a computer system (1000) includes one or more processor(s) (1002), associated memory (1004) (e.g., random access memory (RAM), cache memory, flash memory, etc.), a storage device (1006) (e.g., a hard disk, an optical drive such as a compact disk drive or digital video disk (DVD) drive, a flash memory stick, etc.), and numerous other elements and functionalities typical of today's computers (not shown). The computer (1000) may also include input means, such as a keyboard (1008), a mouse (1010), or a microphone (not shown). Further, the computer (1000) may include output means, such as a monitor (1012) (e.g., a liquid crystal display (LCD), a plasma display, or cathode ray tube (CRT) monitor). The computer system (1000) may be connected to a network (1014) (e.g., a local area network (LAN), a wide area network (WAN) such as the Internet, or any other similar type of network) via a network interface connection (not shown). Those skilled in the art will appreciate that many different types of computer systems exist, and the aforementioned input and output means may take other forms, now known or later developed. Generally speaking, the computer system (1000) includes at least the minimal processing, input, and/or output means necessary to practice embodiments of continuous measurement of heterogeneity of geomaterials.

Further, those skilled in the art will appreciate that one or more elements of the aforementioned computer system (1000) may be located at a remote location and connected to the other elements over a network. Further, embodiments of continuous measurement of heterogeneity of geomaterials may be implemented on a distributed system having a plurality of nodes, where each portion of the embodiments may be located on a different node within the distributed system. In one or more embodiments, the node corresponds to a computer system. Alternatively, the node may correspond to a processor with associated physical memory. The node may alternatively correspond to a processor with shared memory and/or resources. Further, software instructions to perform embodiments of continuous measurement of heterogeneity of geomaterials may be stored on a computer readable medium such as a compact disc (CD), a diskette, a tape, or any other computer readable storage device.

One or more embodiments of continuous measurement of heterogeneity of geomaterials may enable better selection of core sections or side wall plugs, better sampling and characterization of cluster units, more accurate development of models between cluster units (defined at log resolution), and measured continuous and discrete material properties. Also, because heterogeneity is now described in quantitative terms, the one or more embodiments of continuous measurement of heterogeneity of geomaterials may enable optimization of sampling strategies for laboratory testing characterization, guiding previously descriptive analysis of geologic and petrologic characterization and making these quantitative, characterization. The characterization of quantitative properties may be available at discrete locations (e.g., relationships of texture, composition and material properties, grain size distributions, fracture density and orientation, bed boundaries, transitional or sharp boundaries, transitional or sharp sequences, etc.). Other applications may include, but are not be limited to, integration of other laboratory measurements obtained at discrete locations and/or continuous measurements.

While continuous measurement of heterogeneity of geomaterials has been described with respect to a limited number of embodiments, those skilled in the art, having benefit of this disclosure, will appreciate that other embodiments can be devised which do not depart from the scope of continuous measurement of heterogeneity of geomaterials as disclosed herein. Accordingly, the scope of continuous measurement of heterogeneity of geomaterials should be limited only by the attached claims.

What is claimed is:

1. A method for continuous measurement of heterogeneity of geomaterials, comprising:
identifying a core section from a first well within a field;
obtaining the core section from the first well;
obtaining a continuous measurement of the core section;
overlaying the continuous measurement with a portion of a log response for the first well to obtain an overlay;
associating an observation with the overlay to obtain an integrated overlay;
analyzing the integrated overlay to determine a heterogeneity of the core section;
identifying a location in the core section from which to obtain a sample based on the heterogeneity;
obtaining the sample from the core section;
analyzing the integrated overlay based on the sample to obtain an analysis result;
developing a continuous model for the first well using the log response and the analysis result; and
presenting the continuous model.

2. The method of claim 1, further comprising:
predicting a material property for a second well in the field using the continuous model.

3. The method of claim 1, wherein the observation comprises geologic properties.

4. The method of claim 1, wherein the observation comprises petrologic properties.

5. The method of claim 1, wherein the observation comprises a visual representation of the core section.

6. The method of claim 1, wherein identifying the core section comprises:
obtaining a log response for a second well in the field; and
performing a cluster analysis on the log response for the second well to identify a cluster for which continuous measurement is required, wherein the core section is associated with the cluster.

7. The method of claim 1, wherein analyzing the integrated overlay based on the sample to obtain the analysis result comprises:
performing discrete measurements of the sample;
updating the integrated overlay based on the discrete measurements; and
performing a statistical analysis of the updated integrated overlay to obtain the analysis result.

8. The method of claim 1, wherein obtaining the continuous measurement of the core section comprises analyzing a composition of the core sample and a texture of the core sample, and wherein the analysis is presented on a ternary diagram.

9. The method of claim 8, wherein results of the analysis of the texture of the core sample comprises information associated with grain size distribution.

10. The method of claim 8, wherein results of the analysis of the texture of the core sample comprises information associated with bed boundaries.

11. The method of claim 8, wherein results of the analysis of the texture of the core sample comprises information associated with distance between beds.

12. The method of claim 1, wherein overlaying the continuous measurement with the portion of the log response comprises:
determining a common scale based on the log response; and
scaling the continuous measurement to the common scale prior to generate the integrated overlay.

13. The method of claim 1, wherein the continuous measurement is used to measure fracture characteristics in the core sample.

14. The method of claim 1, wherein the continuous measurement is conducted under a simulated in-situ condition.

15. A computer readable medium comprising instructions executable by a processor to perform a method, the method comprising:
identifying a core section from a well within a field;
obtaining the core section from the well;
obtaining a continuous measurement of the core section;
overlaying the continuous measurement with a first log response for the core section to obtain an overlay;
associating an observation with the overlay to obtain a first integrated overlay;
comparing the first log response with a second log response for the core section;
determining that the second log response more accurately characterizes the core section;
repeating the overlaying and associating using the second log response to obtain a second integrated overlay;
analyzing the second integrated overlay to identify a location in the core section from which to obtain a sample;
obtaining the sample from the core section;
analyzing the sample to obtain an analysis result; and
developing a model for the field using the analysis result.

16. The computer readable medium of claim 15, wherein the second log response for the core section is obtained by using a relationship between a log response for the well and a depth of the core section.

17. A device for determining heterogeneity of a core section, comprising:
means for performing a first pass over of the core section to obtain continuous measurements of the core section;
means for combining the continuous measurements with a log response and an observation to obtain an integrated overlay, the observation associated with data related to the core section;
means for identifying locations within the core section from which to obtain samples using the integrated overlay; and
means for obtaining the samples using the identified locations during a second pass over the core section, the samples selected to provide information associated with heterogeneous portions of the core section.

18. The device of claim 17, further comprising:
means for developing a model of the core section based on the analysis of the sample, wherein the model defines a material property for each of the heterogeneous portions of the core section.

19. The device of claim 17, further comprising:
means for evaluating the validity of a cluster analysis, wherein the cluster analysis is used to identify the core section is to be obtained for analysis using continuous measurements.

20. The device of claim 17, further comprising:
a display means for presenting the integrated overlay.
